(19) United States
(12) Patent Application Publication
(10) Pub. No.: US 2022/0284506 A1
(43) Pub. Date: Sep. 8, 2022

(54) TECHNOLOGIES FOR USING MACHINE LEARNING TO DETERMINE CREDIT WORTHINESS ASSOCIATED WITH MERCHANT PRODUCTS AND SERVICES

(71) Applicant: Todd Follmer, Park City, UT (US)

(72) Inventor: Todd Follmer, Park City, UT (US)

(21) Appl. No.: 17/192,299

(22) Filed: Mar. 4, 2021

(51) Int. Cl. G06Q 40/02; G06K 9/62; G06N 20/00; G06Q 30/02

(52) U.S. Cl. CPC G06Q 40/025; G06K 9/6256; G06N 20/00; G06Q 30/0204

(57) ABSTRACT

Systems and methods for using machine learning to assess consumer creditworthiness for loans related to products and/or services offered by merchants. According to certain aspects, a server computer may determine, using a machine learning model in combination with consumer data and loan parameters specified by a merchant, whether a consumer is approved for a loan for the purchase of a product or service offered by the merchant. The server computer may interface with a merchant device to adjust certain loan parameters, such as in an attempt to approve a loan that would otherwise be denied.

### FIELD

The present disclosure is directed to using machine learning or artificial intelligence to determine the creditworthiness of consumers applying for credit in conjunction with the purchase of products and services from merchants. More particularly, the present disclosure is directed to platforms and technologies for using machine learning in combination with certain merchant-specified parameters to determine whether to extend credit to consumers for the purchase of merchant products or services.

### BACKGROUND

Generally, consumers seek credit for a variety of purposes. For example, consumers seek secured loans for property mortgages, secured installment loans for large purchases (e.g., automobiles or furniture), and unsecured loans for other purposes. In determining whether to extend credit to a particular consumer, lenders such as banks and credit card companies typically review that consumer's credit report, and if the credit report contains information or data that meets requirements of the lender, then the lender may approve credit to be extended to the consumer.

In certain situations, it may be advantageous for merchants to partner with lenders in extending credit to consumers for the purchase of products and/or services offered by the merchants. For example, a merchant may be a physician who offers elective surgeries to patients. In this example, a given patient may not be able to immediately afford the full cost of the surgery and may wish for credit to be extended to allow the patient to borrow money to pay for the procedure. However, lenders may not be able to accurately or effectively assess the creditworthiness of such patients. Additionally, merchants are not able to effectively or efficiently adjust costs or other parameters associated with the products or services, or impact terms associated with approval of credit to consumers through their own actions.

Accordingly, there is an opportunity for lenders to employ various technologies to more accurately and effectively assess the creditworthiness of such patients, and for merchants to employ various technologies to more effectively and efficiently adjust costs associated with the products or services, or terms associated with approval of credit to consumers.

### SUMMARY

In an embodiment, a computer-implemented method of using machine learning to facilitate loans to consumers by a lender is provided. The computer-implemented method may include: training, by a computer processor, a machine learning model using a set of training data associated with a set of consumers, the set of training data indicating a set of financial parameters associated with the set of consumers; storing the machine learning model in a memory; receiving, by the computer processor from an electronic device associated with a consumer, a request to extend credit to the consumer for purchase of a product or performance of a service offered by a merchant, the request comprising a set of parameters associated with the consumer; accessing a set of requirements specified by the merchant for the purchase of the product or the performance of the service, the set of requirements comprising (i) a cost for the purchase of the product or the performance of the service, and (ii) a reserve amount or a discount amount associated with approval of the credit being extended to the consumer; analyzing, by the computer processor using the machine learning model, the set of parameters associated with the consumer in combination with the set of requirements specified by the merchant; and based on the analyzing, outputting, by the machine learning model, an indication of whether the consumer is approved for the credit to be extended to cover the cost for the purchase of the product or the performance of the service.

In another embodiment, a system for using machine learning to facilitate loans to consumers by a lender is provided. The system may include a transceiver, a memory storing instructions and data associated with a machine learning model, and a processor interfaced with the transceiver and the memory. The processor may be configured to execute the instructions to cause the processor to: train a machine learning model using a set of training data associated with a set of consumers, the set of training data indicating a set of financial parameters associated with the set of consumers, store the machine learning model in the memory, receive, via the transceiver from an electronic device associated with a consumer, a request to extend credit to the consumer for purchase of a product or performance of a service offered by a merchant, the request comprising a set of parameters associated with the consumer, access a set of requirements specified by the merchant for the purchase of the product or the performance of the service, the set of requirements comprising (i) a cost for the purchase of the product or the performance of the service, and (ii) a reserve amount or a discount amount associated with approval of the credit being extended to the consumer, analyze, using the machine learning model, the set of parameters associated with the consumer in combination with the set of requirements specified by the merchant, and based on the analyzing, output, by the machine learning model, an indication of whether the consumer is approved for the credit to be extended to cover the cost for the purchase of the product or the performance of the service.

Further, in an embodiment, a non-transitory computer-readable storage medium configured to store instructions executable by a computer processor is provided. The instructions may include: instructions for training a machine learning model using a set of training data associated with a set of consumers, the set of training data indicating a set of financial parameters associated with the set of consumers; instructions for storing the machine learning model in a memory; instructions for receiving, from an electronic device associated with a consumer, a request to extend credit to the consumer for purchase of a product or performance of a service offered by a merchant, the request comprising a set of parameters associated with the consumer; instructions for accessing a set of requirements specified by the merchant for the purchase of the product or the performance of the service, the set of requirements comprising (i) a cost for the purchase of the product or the performance of the service, and (ii) a reserve amount or a discount amount associated with approval of the credit being extended to the consumer; instructions for analyzing, using the machine learning model, the set of parameters associated with the consumer in combination with the set of requirements specified by the merchant; and instructions for, based on the analyzing, outputting, by the machine learning model, an indication of whether the consumer is approved for the credit to be extended to cover the cost for the purchase of the product or the performance of the service.

### BRIEF DESCRIPTION OF THE FIGURES

FIG. 1A depicts an overview of components and entities associated with the systems and methods, in accordance with some embodiments.

FIG. 1B depicts an overview of certain components configured to facilitate the systems and methods, in accordance with some embodiments.

FIG. 2 is an example signal diagram illustrating functionalities associated with assessing creditworthiness for consumers and accounting for merchant parameters.

FIG. 3 is an example flowchart associated with using machine learning to facilitate loans to consumers by a lender.

### DETAILED DESCRIPTION

The present embodiments may relate to, inter alia, platforms and technologies for assessing credit worthiness of consumers for the extension of credit to pay for the cost of products and/or services offered by merchants. According to certain aspects, systems and methods may train a machine learning model using financial and other data associated with a set of consumers, to be used to assess creditworthiness of certain consumers for the purchase of various products and/or services. A merchant may, for products and/or services offered by the merchant, specify certain parameters (e.g., a reserve amount, a discount amount, etc.) to be used in combination with the machine learning model by a lender server for assessing the creditworthiness of the consumers. The systems and methods may enable the merchant to adjust the parameters, such as in an attempt to approve a loan that may otherwise be denied.

The systems and methods therefore offer numerous benefits. In particular, lenders may employ the machine learning models to accurately and effectively assess the creditworthiness of customers seeking loans for products and/or services. Additionally, the systems and methods may enable merchants to specify certain loan parameters (e.g., reserve amounts and/or discount amounts) that offer merchants flexibility in pricing and risk, and that may result in additional customers for the merchants. Moreover, consumers are afforded with a platform to efficiently and effectively apply for credit to be extended for the performance of a service or the purchase of a product. It should be appreciated that additional benefits are envisioned.

The systems and methods discussed herein address a challenge particular to consumer lending platforms. The challenge relates to a difficulty in accurately assessing credit worthiness for certain consumers, as well as offering flexibility to merchants that offer products and services. This is especially apparent when parameters associated with approval of a loan are fixed or static. Conventionally, merchants have fixed costs or prices for products and services, which a lender accounts for when determining whether to approve loans. However, these conventional systems do not allow the merchants any flexibility in accepting different costs or prices or otherwise taking on risk in association with the loan approval. The systems and methods offer capabilities to solve these problems by employing machine learning models in combination with merchant-specified parameters to assess consumer creditworthiness. Further, the systems and methods automatically determine loan adjustments that may be needed for loan approval, and enable merchants to approve of the loan adjustments. Further, because the systems and methods employ communication between and among multiple devices and components, the systems and methods are necessarily rooted in computer technology in order to overcome the noted shortcomings that specifically arise in the realm of consumer lending platforms.

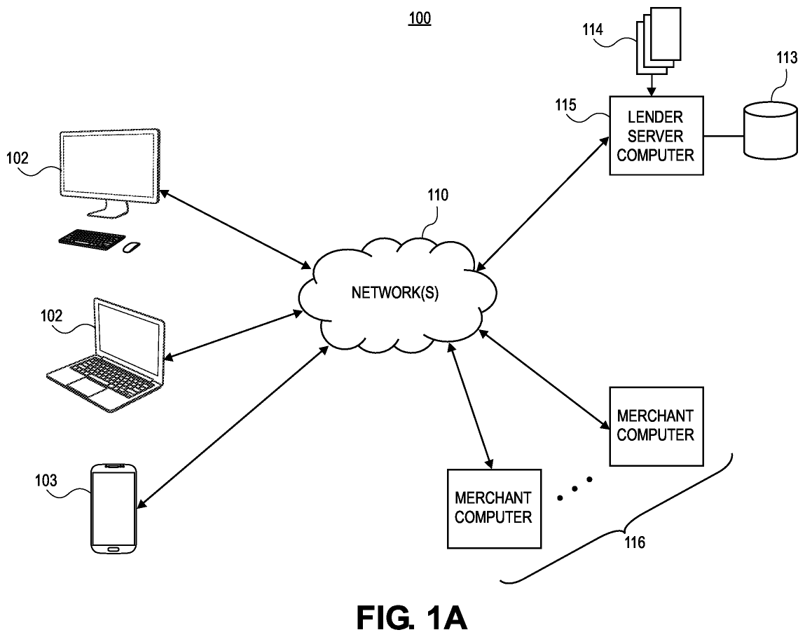

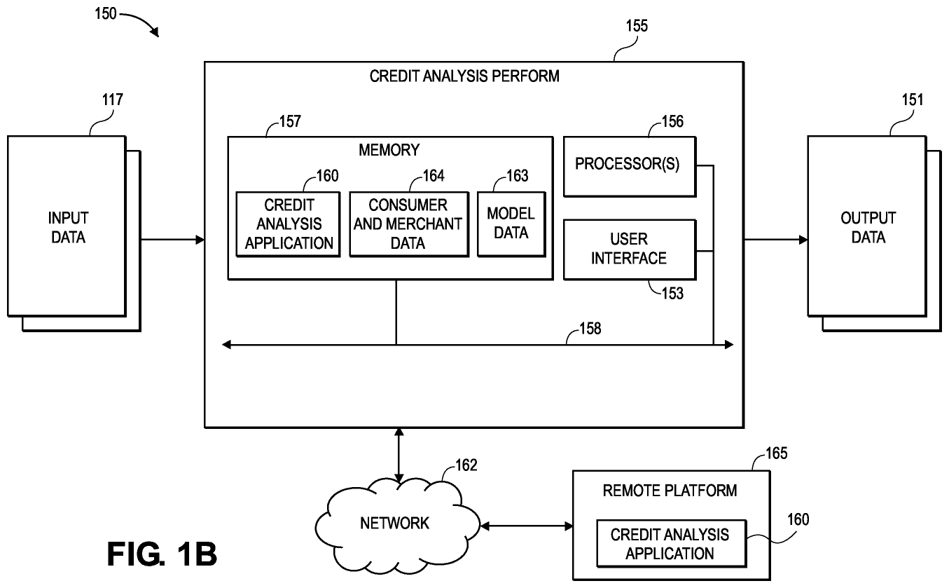

FIG. 1A illustrates an overview of a system 100 of components configured to facilitate the systems and methods. It should be appreciated that the system 100 is merely an example and that alternative or additional components are envisioned.

As illustrated in FIG. 1A, the system 100 may include a set of electronic devices 101, 102, 103. Each of the electronic devices 101, 102, 103 may be any type of electronic device such as a mobile device (e.g., a smartphone), desktop computer, notebook computer, tablet, phablet, GPS (Global Positioning System) or GPS-enabled device, smart watch, smart glasses, smart bracelet, wearable electronic, PDA (personal digital assistant), pager, computing device configured for wireless communication, and/or the like. In embodiments, any of the electronic devices 101, 102, 103 may be an electronic device associated with an individual (e.g., a consumer seeking a loan) or an entity such as a company, business, corporation, or the like (e.g., a server computer or machine).

The electronic devices 101, 102, 103 may communicate with a lender server computer 115 via one or more networks 110. In embodiments, the network(s) 110 may support any type of data communication via any standard or technology (e.g., GSM, CDMA, VoIP, TDMA, WCDMA, LTE, EDGE, OFDM, GPRS, EV-DO, UWB, Internet, IEEE 802 including Ethernet, WiMAX, Wi-Fi, Bluetooth, 4G/5G/6G, Edge, and others). The server computer 115 may be associated with an entity such as a company, business, corporation, or the like, where the entity may be a lender (e.g., a bank, credit union, or other financial institution) in the business of loaning money to consumers, businesses, or other individuals or entities. The server computer 115 may include various components that support communication with the electronic devices 101, 102, 103.

The server computer 115 may communicate with one or more merchant computers 116 via the network(s) 110. Each of the merchant computers 116 may be any type of electronic device such as a mobile device (e.g., a smartphone), desktop computer, notebook computer, tablet, phablet, GPS (Global Positioning System) or GPS-enabled device, smart watch, smart glasses, smart bracelet, wearable electronic, PDA (personal digital assistant), pager, computing device configured for wireless communication, and/or the like. In embodiments, each of the merchant computers 116 may be associated with a merchant, business, corporation, individual, or the like (as used herein, generally, “merchant”) that may offer products and/or services for sale or for performance. For example, the merchant computer 116 may be associated with a physician who may offer procedures or surgeries for patients. For further example, the merchant computer 116 may be associated with a furniture dealer who may sell furniture to consumers. It should be appreciated that various types of merchants are envisioned, each offering some combination of products and services for sale or performance. According to embodiments, each of the merchant computers 116 may store data or information indicative of the costs of the products and/or services, as well as any specified discount and/or reserve amounts, as will be subsequently described.

The server computer 115 may access, retrieve, or generate training dataset(s) 116, for example from a combination of one or more of the electronic devices 101, 102, 103, one or more of the merchant computers 116, and/or other data sources. According to embodiments, the set of training datasets 116 may indicate financial, demographic, and other information associated with a set of consumers, which may or may not include the consumers associated with the set of electronic devices 101, 102, 103.

The server computer 115 may employ various machine learning and/or artificial intelligence (generally, “machine learning”) techniques, calculations, algorithms, and the like to generate a set of machine learning models using the training dataset(s) 116. In particular, the server computer 115 may initially train a set of machine learning models using the training dataset(s) 116 and then apply or input a validation set into a set of generated machine learning models to determine which of the machine learning models is most accurate or otherwise may be used as the final or selected machine learning model.

According to embodiments, the server computer 115 may input, into the generated machine learning models, a set of input data (which may be a set of real-world consumer data) associated with an additional set of consumers. In embodiments, the set of input data may include data associated with an application for credit to be extended to a given consumer (e.g., a consumer associated with one of the electronic devices 101, 102, 103) to cover the cost for a purchase of a product or a performance of a service. The machine learning model may output a result which may include an indication of whether the given consumer is approved for the credit to be extended to cover the cost for the purchase of the product or the performance of the service. A user of the electronic devices 101, 102, 103 (e.g., the consumer) may review the result(s) or output(s) and make decisions accordingly. In embodiments, a user may access the result(s) or output(s) directly from the server computer 115. In embodiments, a merchant(s) of the respective merchant computers 116 may use the merchant computers 116 to modify various terms or parameters of a loan, such as if an application is not approved, as will be discussed herein.

The server computer 115 may be configured to interface with or support a memory or storage 113 capable of storing various data, such as in one or more databases or other forms of storage. According to embodiments, the storage 113 may store data or information associated with the machine learning models that are generated by the server computer 115. Additionally, the server computer 115 may access the data associated with the stored machine learning models to input a set of inputs into the machine learning models.

Although depicted as a single server computer 115 in FIG. 1A, it should be appreciated that the server computer 115 may be in the form of a distributed cluster of computers, servers, machines, cloud-based services, or the like. In this implementation, the entity may utilize the distributed server computer(s) 115 as part of an on-demand cloud computing platform. Accordingly, when the electronic devices 101, 102, 103 and the merchant computer(s) 116 interface with the server computer 115, the electronic devices 101, 102, 103 and the merchant computer(s) may actually interface with one or more of a number of distributed computers, servers, machines, or the like, to facilitate the described functionalities.

Although three (3) electronic devices 101, 102, 103, two (2) merchant computers 116, and one (1) server computer 115 are depicted in FIG. 1A, it should be appreciated that greater or fewer amounts are envisioned. For example, there may be multiple server computers, each one associated with a different entity. FIG. 1B depicts more specific components associated with the systems and methods.

FIG. 1B an example environment 150 in which a set of input data 151 is processed into output data 152 via a credit analysis platform 155, according to embodiments. In one implementation, the set of input data 151 may be a training dataset. The credit analysis platform 155 may be implemented on any computing device, including the server computer 115 (or in some implementations, one or more of the electronic devices 101, 102, 103 or one or more merchant computers 116) as discussed with respect to FIG. 1A. Components of the computing device may include, but are not limited to, a processing unit (e.g., processor(s) 156), a system memory (e.g., memory 157), and a system bus 158 that couples various system components including the memory 157 to the processor(s) 156. The computing device may further include various communication components (e.g., transceivers and ports) that may facilitate data communication with one or more additional computing devices.

In some embodiments, the processor(s) 156 may include one or more parallel processing units capable of processing data in parallel with one another. The system bus 158 may be any of several types of bus structures including a memory bus or memory controller, a peripheral bus, or a local bus, and may use any suitable bus architecture. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

The credit analysis platform 155 may further include a user interface 153 configured to present content (e.g., the content of the input data 151 and/or the output data 152, and information associated therewith). Additionally, a user may make selections to the content via the user interface 153, such as to navigate through different information, review certain input data, and/or other actions. The user interface 153 may be embodied as part of a touchscreen configured to sense touch interactions and gestures by the user. Although not shown, other system components communicatively coupled to the system bus 158 may include input devices such as cursor control device (e.g., a mouse, trackball, touch pad, etc.) and keyboard (not shown). A monitor or other type of display device may also be connected to the system bus 158 via an interface, such as a video interface. In addition to the monitor, computers may also include other peripheral output devices such as a printer, which may be connected through an output peripheral interface (not shown).

The memory 157 may include a variety of computer-readable media. Computer-readable media may be any available media that can be accessed by the computing device and may include both volatile and nonvolatile media, and both removable and non-removable media. By way of non-limiting example, computer-readable media may comprise computer storage media, which may include volatile and nonvolatile, removable and non-removable media implemented in any method or technology for storage of information such as computer-readable instructions, routines, applications (e.g., a credit analysis application 160), data structures, program modules or other data.

Computer storage media may include, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the processor 156 of the computing device.

The credit analysis platform 155 may operate in a networked environment and communicate with one or more remote platforms, such as a remote platform 165, via a network(s) 162, such as a local area network (LAN), a wide area network (WAN), telecommunications network, or other suitable network. The remote platform 165 may be implemented on any computing device, including one or more of the electronic devices 101, 102, 103, one or more of the merchant computers 116, or the server computer 115 as discussed with respect to FIG. 1A, and may include many or all of the elements described above with respect to the platform 155. In some embodiments, the credit analysis application 160 may be stored and executed by the remote platform 165 instead of by or in addition to the platform 155.

The credit analysis application 160 may employ machine learning techniques such as, for example, a regression analysis (e.g., a logistic regression, linear regression, random forest regression, probit regression, or polynomial regression), classification analysis, k-nearest neighbors, decisions trees, random forests, boosting, neural networks, support vector machines, deep learning, reinforcement learning, Bayesian networks, or the like. When the data 151 is a training dataset (which may include real-world consumer data), the credit analysis application 160 may analyze/process the data 151 to generate the machine learning model for storage as part of model data 163 that may be stored in the memory 157.

When the data 151 comprises real-world consumer data to be analyzed using the machine learning model, the credit analysis application 160 may analyze or process the data 151 using the machine learning model to generate the output data 152 that may comprise various metrics and information corresponding to the trained machine learning model. In embodiments, the output data 152 may indicate whether a consumer is approved or denied for a loan. The memory 157 may be configured to store various consumer and merchant data 164 that the credit analysis platform 155 may use to generate machine learning model(s) or may analyze using the machine learning model(s). The merchant data 164 may be associated with one or more merchants, and may indicate costs for various products and/or services, reserve and/or discount amounts specified by the merchants, and/or other information and, in some implementations, may be included as part of the input data 151.

The credit analysis application 160 (or another component) may cause the output data 152 (and, in some cases, the training or input data 151) to be displayed on the user interface 153 for review by the user of the credit analysis platform 155. The user may select to review and/or modify the displayed data. For instance, the user may review the output data 152 to assess results of loan applications.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processor 156 (e.g., working in connection with an operating systems) to facilitate the functions as described herein. In this regard, the program code may be implemented in any desired language, and may be implemented as machine code, assembly code, byte code, interpretable source code or the like (e.g., via Golang, Python, Scala, C, C++, Java, Actionscript, Objective-C, Javascript, CSS, XML, R, Stata, AI libraries). In some embodiments, the computer program product may be part of a cloud network of resources.

In some embodiments, the computer program product may be part of a cloud network of resources. Generally, each of the data 151 and the data 152 may be embodied as any type of electronic document, file, template, etc., that may include various textual content, and may be stored in memory as program data in a hard disk drive, magnetic disk and/or optical disk drive in the credit analysis platform 155 and/or the remote platform 165.

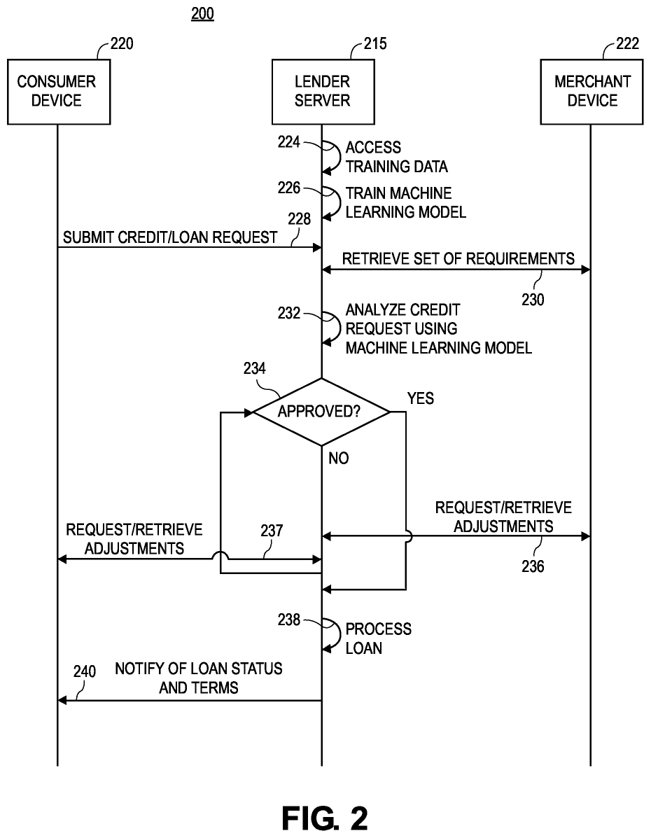

FIG. 2 is a signal diagram 200 depicting various functionalities associated with the systems and methods. The signal diagram 200 includes a consumer device 220 associated with a consumer (such as one of the electronic devices 101, 102, 103 as discussed with respect to FIG. 1A), a lender server 215 (such as the lender server computer 115 as discussed with respect to FIG. 1A), and a merchant device 222 associated with a merchant (such as one of the merchant computers 116 as discussed with respect to FIG. 1A).

The signal diagram 200 may begin when the lender server 215 accesses (224) a set of training data. According to embodiments, the set of training data may include various information associated with a set of consumers, including one of more of the following: demographic information (e.g., age, gender, address, etc.), financial information including checking accounts, savings accounts and investment accounts, credit information, home ownership, car ownership, recreational interests, social media information, employment status, employer information, health insurance information, and/or the like. The set of training data may further indicate, for each of the set of consumers, terms of a loan that the consumer previously applied for, what the loan is for, and an indication of whether the consumer was approved for the loan. It should be appreciated that the set of training data may include, at least in part, generated data corresponding to “test” (i.e., imaginary) consumers and test loans. It should further be appreciated that the set of training data may be associated with one or more merchants, and may indicate costs for various products and/or services, reserve and/or discount amounts specified by the merchants, and/or other information.

The lender server 215 may train (226) a machine learning model(s) using the set of training data. As a result, the machine learning model may indicate the consumer information, whether loan applications were approved or denied, and the terms or any approved or denied loans.

The consumer device 220 may submit (228) a credit or loan request to the lender server 215. In embodiments, the credit or loan request may identify a consumer applying for a loan, what the loan is for (e.g., a service or product offered by a merchant), the requested loan amount, financial information or other information the be used in association with underwriting the loan, and/or other data or information. It should be appreciated that the lender server 215 may review the loan request and request more information from the consumer device 220, which the consumer device 220 may in turn send to the lender server 215.

The lender server 215 may retrieve (230), from the merchant device 222, or otherwise access a set of requirements for a merchant associated with the merchant device 222, where the merchant may correspond to the credit or loan request received in (228). According to embodiments, the set of requirements may specify various parameters, metrics, requirements, and the like in association with a service or product that the merchant may perform and/or offer for sale. In particular, the set of requirements may identify a set of products and/or services, as well as indicate a cost of each product or service in the set of products and/or services (i.e., what the merchant charges for a particular product or service). The set of requirements may also indicate, for each product or service in the set of products and/or services, a reserve amount and/or a discount amount.

According to embodiments, a reserve amount is an amount of money specified by the merchant that may be set aside to cover credit losses. For example, assume that a merchant offers a service that has a cost of $500. The merchant can specify a reserve amount of $300 (i.e., 60% of the cost). Accordingly, when a borrower/consumer applies for a loan to cover the $500 cost, the lender may approve the loan for the $500 cost, and the lender initially pays the merchant a total of $200 (i.e., the cost minus the reserve amount). Subsequently, the borrower pays back (or does not pay back) the lender according to the terms of the loan. If and when the amount the borrower pays back starts to exceed the $200 paid to the merchant (not accounting for interest), the lender will start sending the excess payments (e.g., in the form of dividend payments) to the merchant, up to an amount of $300 (i.e., to cover the difference between the amount initially paid to the merchant and the cost). Therefore, the merchant will receive a minimum of $200 (i.e., the cost minus the reserve amount), and if the borrower pays back an amount in excess of the $200 (not accounting for interest), the merchant will receive up to a total of $500 depending on how much in excess of $200 the borrower pays back.

According to embodiments, a discount amount represents how much of a reduction in the cost that a merchant is willing to absorb to perform a service or sell a product. For example, assume that a merchant offers a service that has a cost of $500. The merchant can specify a discount amount of $100 (i.e., a discount percentage of $20%). When a borrower applies for a loan to cover the $500 cost, the lender may approve the loan for the $500 cost, and the lender pays the merchant a total of $400 (i.e., the cost minus the discount amount). Subsequently, the borrower pays back (or does not pay back) the lender according to the terms of the loan. However, if the borrower pays back the loan in excess of the amount of $400 initially paid to the merchant, the lender will not send any excess amount to the merchant. That is, the merchant will receive a total of $400 regardless of how much of the original $500 loan the borrower pays back to the lender.

Generally, because the reserve amount structure has the potential to pay back the entire loan amount to a given merchant, any specified reserve amount for the given merchant may be (but may not be) more than any corresponding specified discount amount. This is because the merchant has the potential to collect more than the specified reserve amount, but does not have the potential to collect more than the specified discount amount.

According to embodiments, the discount amount or reserve amount may be a “bonus” amount, such as to incentivize a merchant into doing business with a lender. This may be particularly applicable in situations in which a consumer has favorable credit and is likely to pay back the loan according to the loan parameters. For example, a lender may notify a merchant that a consumer is seeking a loan of $1,000 and that the lender is willing to pay the merchant a total of $1,100 (i.e., a “bonus” amount of $100).

The lender server 215 may analyze (232) the credit request received from the consumer device 220 using the machine learning model. According to embodiments, the lender server 215 may input the data associated with the credit request along with data associated with the set of requirements associated with the merchant into the machine learning model. In analyzing the credit request, the lender server 215 may cause the machine learning model to output an indication of whether the consumer is approved for credit to be extended to cover the cost for the purchase of the product or the performance of the service, as specified in the credit request, where the outputted indication may be determined based on inputting the relevant data and parameters into the trained machine learning model.

Additionally, in analyzing the credit request, the lender server 215 may or may not account for the set of requirements specified by the merchant and applicable to the product or service for which the loan is sought. In a scenario, the consumer may not be approved for the loan when the lender server 215 does not account for an applicable reserve amount or discount amount. In this situation, the lender server 215 may account for any already-specified reserve amount or discount amount, and output an indication of whether the consumer is approved when accounting for the already-specified reserve amount or discount amount. For example, if the consumer originally requests a loan in the amount of $1,000 for a service having a specified discount amount of $100 but is not approved for the full $1,000 amount, the lender server 215 may determine, based on an analysis using the machine learning model, that the consumer is approved for the $1,000 amount when accounting for the lender only having to pay $900 to the merchant, when accounting for the discount.

Further, in analyzing the credit request and in situations where the consumer may not be approved for the loan, the lender server 215 may determine parameters for the loan that would result in the consumer being approved for the loan. In particular, the parameters may indicate one or both of a reserve amount or a discount amount that the merchant would need to agree to in order for the loan to be approved. Continuing with the above example, the lender server 215 may determine that the consumer is not approved for either the original $1,000 loan (i.e., without a reserve or discount amount) or a loan that accounts for the discount amount of $900, but that the consumer would be approved for the $1,000 loan if the merchant agrees to either of the following: a reserve amount of $300 or a discount amount of $250 (i.e., a discount of 25%).

Additionally, in analyzing the credit request, the lender server 215 may account for various data or information associated with the merchant. In particular, a given merchant may have a “good” (or “bad”) history of its consumers paying off (or not paying off) their loans. Additionally or alternatively, certain services and/or procedures offered by various merchants may have a better (or worse) history of loan payoff.

Based on the analysis of (232), the lender server 215 may output (234) the indication of whether the consumer is approved for the loan. If the indication is “YES”, processing may proceed to (238). If the indication is “NO”, the lender server 215 may perform various adjustments in an effort to approve the loan.

In particular, the lender server 215 may determine that, to approve the loan, a checking account (or otherwise an account associated with a financial institution) of the consumer be appended to the underwriting file associated with the consumer. In turn, the consumer may facilitating “linking” or appending an account, such as via an application programming interface (API) with the appropriate financial institution.

Alternatively or additionally, the lender server 215 may determine that, to approve the loan, the consumer is required to make a down payment or upfront payment, which may be a percentage (e.g., 10%, 20%, or another percentage) or an amount (e.g., $100, $500, or another amount) that can be applied to the loan amount. For example, the lender server 215 may determine that, to approve a $1,000 loan, the consumer is required to remit a down payment of 20% (i.e., $200) for the loan to be approved. According to embodiments, the consumer may remit the down payment via a checking account, credit card payment, or other type of payment. Item 237 of FIG. 2 illustrates the request and retrieval of various requirements and information associated with the appending or amending of the loan application to achieve approval.

Alternatively or additionally, the lender server 215 may request or retrieve (236), from the merchant device 222, an adjustment(s) to the loan parameters in an effort to potentially approve the loan. In particular, the lender server 215 may determine loan adjustment parameters (e.g., a modified reserve amount and/or a discount amount) that would result in the loan being approved, and transmits those loan adjustment parameters to the merchant device 222.

An individual accessing the merchant device 222 may review the loan adjustment parameters and determine whether to accept the loan adjustment parameters (i.e., whether to accept the proposed reserve amount or the proposed discount amount), where the merchant device 222 may transmit, to the lender server 215, an indication of whether the loan adjustment parameters are accepted (or denied), as well as whether the merchant approves the proposed reserve amount or the proposed discount amount. In embodiments, the merchant may input, into the merchant device 222, a “counteroffer” or otherwise additionally-adjusted parameters (e.g., a counter reserve amount and/or a counter discount amount), and the merchant device 222 may transmit the additionally-adjusted parameters to the lender server 215 for the lender server 215 to consider in determining whether the loan is approved. In this situation, the lender server 215 may additionally analyze relevant data to determine whether the loan is approved.

In embodiments, the merchant device 222 may perform the determinations and the communications automatically and without any user intervention, such as if an application executing on the merchant device 222 is programmed to facilitate the functionalities as described herein. In particular, the merchant device 222 may automatically approve or deny any modified reserve amount and/or discount amount proposed by the lender computer 215, for example based on stored data. In either case, the merchant device 222 may transmit an agreement or rejection of the offered loan parameters to the lender server 215; and if the loan is approved or agreed to, processing may proceed to (238), or if the loan is not approved or otherwise rejected, processing may end or proceed to other functionality.

At 238, the lender server 215 may process the loan according to the approved or agreed upon parameters, including whether there is an applicable reserve amount or discount amount. The lender server 215 may notify (240) the consumer device 220 of the status and terms of the loan. It should be appreciated that the loan may be initiated according to the terms. In embodiments, the lender may transfer applicable funds to the merchant (without or without accounting for a discount or reserve amount), the merchant may perform the underlying service or sell the underlying product to the consumer, and the consumer may be obligated to make payments to the lender according to the terms of the loan.

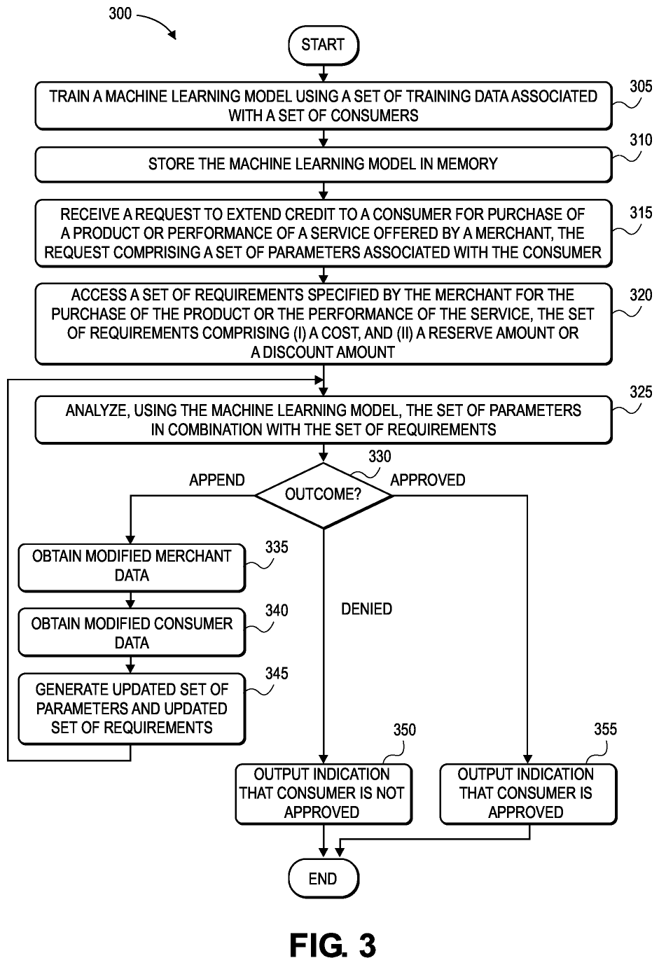

FIG. 3 depicts a block diagram of an example method 300 of using machine learning to facilitate loans to consumers by a lender. The method 300 may be facilitated by an electronic device (such as the server computer 115 or components associated with the credit analysis platform 155 as discussed with respect to FIG. 1B) that may be in communication with additional devices and/or data sources.

The method 300 may begin when the electronic device trains (block 305) a machine learning model using a set of training data associated with a set of consumers, where the set of training data may indicate or include a set of financial parameters associated with the set of consumers. According to some embodiments, the set of financial parameters may be further associated with a set of merchants. The electronic device may store (block 310) the machine learning model in memory.

The electronic device may receive (block 315) a request to extend credit to a consumer for purchase of a product or performance of a service offered by a merchant, where the request may comprise a set of parameters associated with the consumer. The electronic device may access (block 320) a set of requirements specified by the merchant for the purchase of the product or the performance of the service, where the set of requirements may comprise (i) a cost, and (ii) a reserve amount or a discount amount.

The electronic device may analyze (block 325), using the machine learning model, the set of parameters in combination with the set of requirements. Based on the analysis of the machine learning model, the output or outcome (block 330) may indicate that the consumer is approved for the credit to be extended to cover the cost for the purchase of the product or the performance of the service (“APPROVED”), the consumer is denied for the credit to be extended (“DENIED”), or some information or inputs need to be amended in order for the consumer to be approved (“APPEND”).

If the output is “APPEND”, processing may proceed to block 335 in which the electronic device may obtain modified merchant data from the merchant, in an effort to approve for the credit to be extended. In particular, the electronic device may receive, from a merchant device, an adjustment to the reserve amount or the discount amount. It should be appreciated that the electronic device may determine the adjustment to the reserve amount or the discount amount that is needed to approve the credit, and may communicate this information to the merchant device. It should be appreciated that any adjustment to the reserve amount or the discount amount may be specified by the merchant device or received by the electronic device at any time, and may be specified or received automatically or in real-time or near-real-time.

Additionally or alternatively, the electronic device may obtain (block 340) modified consumer data. In embodiments, the electronic device may ask for the consumer to append a checking account to the loan application, add a co-borrower to the loan application, pay a down payment, modify the amount of money requested, or change the loan applications or terms thereof in another manner. It should be appreciated that the electronic device may determine the adjustment or additional requirement(s) that is needed to approve the credit, and may communicate this information to the consumer device.

In embodiments, if the consumer does not or is unwilling to add a checking account, add a co-borrower, and/or remit a down payment, the electronic device may revert back to the merchant device and inquire whether the merchant is willing to lower a reserve amount or increase a discount.

The electronic device may generate (block 345) an updated set of parameters and/or an updated set of requirements based on any modified, added, or additional information received from the merchant device and/or the consumer device. Next, the electronic device may proceed to block 325 in which the electronic device may analyze, using the machine learning model, the updated set of parameters in combination with the updated set of requirements, which may generate the output or outcome as described herein.

If the output from block 330 is “DENIED”, the electronic device may output (block 350) an indication that the consumer is not approved. If the output from block 330 is “APPROVED”, the electronic device may output (block 355) an indication that the consumer is approved. In embodiments, the output may further indicate whether any reserve amount or discount amount is to be applied in association with extending the credit to the consumer.

Although the following text sets forth a detailed description of numerous different embodiments, it should be understood that the legal scope of the invention may be defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that may be permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that may be temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it may be communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

As used herein, the terms “comprises,” “comprising,” “may include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical.

What is claimed is:

1. A computer-implemented method of using machine learning to facilitate loans to consumers by a lender, the computer-implemented method comprising:
training, by a computer processor, a machine learning model using a set of training data associated with a set of consumers, the set of training data indicating a set of financial parameters associated with the set of consumers;
storing the machine learning model in a memory;
receiving, by the computer processor from an electronic device associated with a consumer, a request to extend credit to the consumer for purchase of a product or performance of a service offered by a merchant, the request comprising a set of parameters associated with the consumer;
accessing a set of requirements specified by the merchant for the purchase of the product or the performance of the service, the set of requirements comprising (i) a cost for the purchase of the product or the performance of the service, and (ii) a reserve amount or a discount amount associated with approval of the credit being extended to the consumer;
analyzing, by the computer processor using the machine learning model, the set of parameters associated with the consumer in combination with the set of requirements specified by the merchant; and
based on the analyzing, outputting, by the machine learning model, an indication of whether the consumer is approved for the credit to be extended to cover the cost for the purchase of the product or the performance of the service.

2. The computer-implemented method of claim 1, wherein the indication indicates that the consumer is approved for the credit to be extended, and wherein outputting the indication comprises:
based on the analyzing, outputting, by the machine learning model, (i) the indication, and (ii) an additional indication of whether the reserve amount or the discount amount is to be applied in association with extending the credit to the consumer.

3. The computer-implemented method of claim 1, wherein the indication indicates that the consumer is approved for the credit to be extended, and wherein outputting the indication comprises:
based on the analyzing, outputting, by the machine learning model, (i) the indication, and (ii) an additional indication of a down payment that is required from the consumer before the merchant delivers the product or performs the service.

4. The computer-implemented method of claim 1, further comprising:
receiving, from a merchant device associated with the merchant, an adjustment to the reserve amount or the discount amount associated with the approval of the credit being extended to the consumer.

5. The computer-implemented method of claim 4, wherein receiving the adjustment comprises:
receiving, from the merchant device in real-time or near-real-time, the adjustment to the reserve amount or the discount amount associated with the approval of the credit being extended to the consumer.

6. The computer-implemented method of claim 1, wherein the indication indicates that the consumer is not approved for the credit to be extended, and wherein the method further comprises:
based on the analyzing, determining an adjustment to the set of requirements needed for the consumer to be approved for the credit;
transmitting, to a merchant device associated with the merchant, an indication of the adjustment to the set of requirements; and
receiving, from the merchant device, an approval for the purchase of the product or the performance of the service accounting for the adjustment.

7. The computer-implemented method of claim 6, further comprising:
outputting, by the machine learning model, a subsequent indication indicating that the consumer is approved for the credit to be extended to cover the cost for the purchase of the product or the performance of the service and accounting for the adjustment.

8. The computer-implemented method of claim 1, wherein training the machine learning model comprises:
training, by the computer processor, the machine learning model using the set of training data associated with the set of consumers and a set of merchants that includes the merchant, wherein the set of financial parameters is further associated with the set of merchants.

9. A system for using machine learning to facilitate loans to consumers by a lender, comprising:
a transceiver;
a memory storing instructions and data associated with a machine learning model; and
a processor interfaced with the transceiver and the memory, and configured to execute the instructions to cause the processor to:
train a machine learning model using a set of training data associated with a set of consumers, the set of training data indicating a set of financial parameters associated with the set of consumers,
store the machine learning model in the memory,
receive, via the transceiver from an electronic device associated with a consumer, a request to extend credit to the consumer for purchase of a product or performance of a service offered by a merchant, the request comprising a set of parameters associated with the consumer,
access a set of requirements specified by the merchant for the purchase of the product or the performance of the service, the set of requirements comprising (i) a cost for the purchase of the product or the performance of the service, and (ii) a reserve amount or a discount amount associated with approval of the credit being extended to the consumer,
analyze, using the machine learning model, the set of parameters associated with the consumer in combination with the set of requirements specified by the merchant, and
based on the analyzing, output, by the machine learning model, an indication of whether the consumer is approved for the credit to be extended to cover the cost for the purchase of the product or the performance of the service.

10. The system of claim 9, wherein the indication indicates that the consumer is approved for the credit to be extended, and wherein to output the indication, the processor is configured to:
based on the analyzing, output, by the machine learning model, (i) the indication, and (ii) an additional indication of whether the reserve amount or the discount amount is to be applied in association with extending the credit to the consumer.

11. The system of claim 9, wherein the indication indicates that the consumer is approved for the credit to be extended, and wherein to output the indication, the processor is configured to:
based on the analyzing, output, by the machine learning model, (i) the indication, and (ii) an additional indication of a down payment that is required from the consumer before the merchant delivers the product or performs the service.

12. The system of claim 9, wherein the processor is configured to execute the instructions to further cause the processor to:
receive, via the transceiver from a merchant device associated with the merchant, an adjustment to the reserve amount or the discount amount associated with the approval of the credit being extended to the consumer.

13. The system of claim 12, wherein to receive the adjustment, the processor is configured to:
receive, via the transceiver from the merchant device in real-time or near-real-time, the adjustment to the reserve amount or the discount amount associated with the approval of the credit being extended to the consumer.

14. The system of claim 9, wherein the indication indicates that the consumer is not approved for the credit to be extended, and wherein the processor is configured to execute the instructions to further cause the processor to:
based on the analyzing, determine an adjustment to the set of requirements needed for the consumer to be approved for the credit,
transmit, via the transceiver to a merchant device associated with the merchant, an indication of the adjustment to the set of requirements, and
receive, via the transceiver from the merchant device, an approval for the purchase of the product or the performance of the service accounting for the adjustment.

15. The system of claim 14, wherein the processor is configured to execute the instructions to further cause the processor to:
output, by the machine learning model, a subsequent indication indicating that the consumer is approved for the credit to be extended to cover the cost for the purchase of the product or the performance of the service and accounting for the adjustment.

16. The system of claim 9, wherein to train the machine learning model, the processor is configured to:
train the machine learning model using the set of training data associated with the set of consumers and a set of merchants that includes the merchant, wherein the set of financial parameters is further associated with the set of merchants.

17. A non-transitory computer-readable storage medium configured to store instructions executable by a computer processor, the instructions comprising:
instructions for training a machine learning model using a set of training data associated with a set of consumers, the set of training data indicating a set of financial parameters associated with the set of consumers;
instructions for storing the machine learning model in a memory;
instructions for receiving, from an electronic device associated with a consumer, a request to extend credit to the consumer for purchase of a product or performance of a service offered by a merchant, the request comprising a set of parameters associated with the consumer;
instructions for accessing a set of requirements specified by the merchant for the purchase of the product or the performance of the service, the set of requirements comprising (i) a cost for the purchase of the product or the performance of the service, and (ii) a reserve amount or a discount amount associated with approval of the credit being extended to the consumer;
instructions for analyzing, using the machine learning model, the set of parameters associated with the consumer in combination with the set of requirements specified by the merchant; and
instructions for, based on the analyzing, outputting, by the machine learning model, an indication of whether the consumer is approved for the credit to be extended to cover the cost for the purchase of the product or the performance of the service.

18. The non-transitory computer-readable storage medium of claim 17, wherein the indication indicates that the consumer is approved for the credit to be extended, and wherein the instructions for outputting the indication comprise:
instructions for, based on the analyzing, outputting, by the machine learning model, (i) the indication, and (ii) an additional indication of whether the reserve amount or the discount amount is to be applied in association with extending the credit to the consumer.

19. The non-transitory computer-readable storage medium of claim 17, wherein the instructions further comprise:
instructions for receiving, from a merchant device associated with the merchant, an adjustment to the reserve amount or the discount amount associated with the approval of the credit being extended to the consumer.

20. The non-transitory computer-readable storage medium of claim 17, wherein the indication indicates that the consumer is not approved for the credit to be extended, and wherein the instructions further comprise:
instructions for, based on the analyzing, determining an adjustment to the set of requirements needed for the consumer to be approved for the credit;
instructions for transmitting, to a merchant device associated with the merchant, an indication of the adjustment to the set of requirements; and
